(19) United States
(12) Patent Application Publication
(10) Pub. No.: US 2022/0135830 A1
(43) Pub. Date: May 5, 2022

(54) COLOR COATING PAINT AND METHOD FOR MANUFACTURING THE SAME

(71) Applicant: ATND Company Co., Ltd., Pocheon-si (KR)

(72) Inventor: Kyun Nam KIM, Namyangju-si (KR)

(21) Appl. No.: 17/160,815

(22) Filed: Jan. 28, 2021

(30) Foreign Application Priority Data
Nov. 4, 2020 (KR) 10-2020-0145699

(51) Int. Cl. C09D 133/10; C09D 7/61; C09D 7/65; C09D 7/40; C09D 11/107; C09D 11/037; C09D 11/033; C08J 9/36; F16L 59/02

(52) U.S. Cl. CPC C09D 133/10; C09D 7/61; C09D 7/65; C09D 7/68; C09D 7/69; C08J 2433/10; C09D 11/037; C09D 11/033; C08J 9/365; F16L 59/029; C08J 2321/00; C09D 11/107

(57) ABSTRACT

Discloses is a water-soluble color coating paint for coating a rubber foam thermal insulation material and a method for manufacturing the same, and specifically, a color coating paint and an insulation color coating paint which have excellent adhesion to a porous rubber foam thermal insulation material, and retain elasticity of the thermal insulation material, as well as very improved photocatalytic performance, and a method for manufacturing the same. The color coating paint may be applied to a surface regardless of the material or condition of the surface to be painted, and may be coated to a soft or porous surface due to elasticity provided therein. The coating film produced by the color coating paint blocks 95% or more of the emission of volatile organic compounds from the surface of the foam rubber thermal insulation material into the atmosphere.

### RELATED APPLICATIONS

This application claims priority to Korean Patent Application No. 10-2020-0145699, filed on Nov. 4, 2020 in the Korean Intellectual Property Office, the entire disclosure of which is incorporated herein by reference.

### BACKGROUND

### 1. Field

The present disclosure relates to a water-soluble color coating paint for coating a rubber foam thermal insulation material and a method for manufacturing the same.

### 2. Description of the Related Technology

Air pollution is becoming a primary issue at home and abroad, and techniques for reducing air pollution and purifying indoor and outdoor air are being actively developed. In addition, since the time of indoor life tends to be gradually increased due to an increase in non-face-to-face work such as working at home and online classes, interest and importance of indoor air quality are increased.

Fine dust, which is mainly pointed to as an air pollutant, is composed of primary pollutants directly generated from a pollution source and secondary pollutants generated through a combination of precursors existing in the air. Herein, the primary pollutants can be prevented in a certain amount by defining measures such as a dust collector provided in an exhaust port of a factory as a method of self-reducing the pollution source. However, due to the lack of a feasible method capable of reducing the generation of secondary pollutants, there are difficulties for solving air pollution. The main representative precursors which form the secondary pollutants are sulfur oxide (SOx) and nitrogen oxide (NOx), and it is now urgently required to define measures to reduce these materials.

Korean Patent Registration No. 10-2003436 discloses additional related technologies.

The disclosure of this section is to provide background information relating to the present disclosure. Applicant does not admit that any information contained in this section constitutes prior art.

### SUMMARY

The present disclosure relates to a water-soluble color coating paint for coating a rubber foam thermal insulation material and a method for manufacturing the same, and specifically, to a color coating paint and an insulation color coating paint which have excellent adhesion to a porous rubber foam thermal insulation material, and retain elasticity of the thermal insulation material, as well as very improved photocatalytic performance, and a method for manufacturing the same.

It is an aspect of the present invention to provide a color coating paint which may be applied to a surface regardless of the material or condition of the surface to be painted, and may be applied to a soft or porous surface due to elasticity provided therein.

In addition, another aspect of the present invention is to provide a color coating paint which is capable of further improving a photocatalytic effect and an ultraviolet reflective function by avoiding or minimizing a breakage occurring in a coating film of a paint containing titanium dioxide in a high content.

In addition, another aspect of the present invention is to provide a paint which may be coated on an elastic thermal insulation material or a foam thermal insulation material capable of improving anti-moisture permeability and thermal insulation performance of the thermal insulation material by adding spherical ceramic particles to the color coating paint.

Further, another aspect of the present invention is to provide a color coating paint to which colors may be applied in accordance with a process such as water supply, hot water supply, firefighting, air conditioning, and the like by mixing pigments having colors according to the use, and which enables perfect coloring.

One aspect of the present invention provides a color coating paint including 10 to 40 parts by weight of polyacrylate and a polyurethane mixture, 16 to 40 parts by weight of titanium dioxide, 5 to 10 parts by weight of calcium carbonate, 10 to 20 parts by weight of aluminum hydroxide, 0.5 to 5 parts by weight of a silicone resin, 0.1 to 1 parts by weight of sulfur, 0.5 to 10 parts by weight of a colored pigment, and 40 to 60 parts by weight of water.

In addition, another aspect of the present invention provides, as a color coating paint having increased thermal insulation, a color coating paint including 10 to 40 parts by weight of polyacrylate and a polyurethane mixture, 10 to 30 parts by weight of titanium dioxide, 5 to 15 parts by weight of a filler, 5 to 10 parts by weight of calcium carbonate, 10 to 20 parts by weight of aluminum hydroxide, 0.5 to 5 parts by weight of a silicone resin, 0.1 to 1 parts by weight of sulfur, and 40 to 60 parts by weight of water.

In one embodiment of the present invention, the polyacrylate may include poly butyl acrylate or poly n-butyl methacrylate.

In embodiments of the present invention, a water-soluble acrylic resin which uses water as a solvent is used to impart adhesion with a thermal insulation material.

The polyacrylate is also used as a synthetic resin for acrylic rubber paints and has the same properties as NBR rubber paints, such that coating is performed without a damage to a tissue of a heat insulation material during applying the paint. In addition, the polyacrylate is an acrylate polymer, and is characterized by having excellent transparency, abrasion resistance, elasticity, ozone resistance, and being harmless to the human body. Further, the polyacrylate is a strong adhesive component so as to be completely in close contact with the thermal insulation material, and may withstand a temperature of 170 to 180° C. Since this temperature is higher than 150° C., which is a heat resistance limitation of the rubber foam thermal insulation material, it is possible to increase the heat resistance of the thermal insulation material.

In one embodiment of the present invention, the polyurethane may include polyester urethane (AU), polyether urethane (EU), or a urethane resin.

When adding the polyurethane to the paint, elasticity after drying is doubled. The urethane resin may play a role of enhancing waterproofness and elasticity of a coating agent.

Polyurethane is a generic term for a polymer having a urethane bond in a chemical polymer chain, and is synthesized by bonding isocyanate and an active hydrogen compound such as polyol. The polyurethane has a wide selection range of isocyanates and polyols to be used, thereby allowing various product designs from soft to hard, from elastomer to foam, and has an excellent mechanical strength such as tensile strength, tear strength, elongation, abrasion resistance, etc., with good processability, and thereby being used across industries.

In one embodiment of the present invention, a mixing ratio of the polyacrylate and the polyurethane may be 1:0.1 to 5.

In embodiments of the present invention, an acrylic resin that emits little heavy metals and VOCs is used. If the mixing ratio exceeds 1:5, adhesion that can be applied to elastic paints for construction and equipment cannot be achieved without adding a volatile compound for increasing the adhesion. If the mixing ratio is less than 1:0.1, clogging of nozzles in various coating equipment such as an airless or air gun sprayer is caused during coating construction, such that coating workability is considerably reduced.

An additive of the color coating paint according to embodiments of the present invention will be described in detail below.

Calcium carbonate is also used as a calcium supplement and antacid in the human body, is widely used as an industrial raw material, plays a role of preventing oxidation, and is widely used as a matting agent for paint. In addition, the calcium carbonate increases the tensile strength of the paint, suppresses excessive light reflection, and prevents the paint from curing quickly by binding with sulfur.

Aluminum trihydrate is widely used as an eco-friendly non-toxic and non-corrosive flame retardant, and suppresses and reduces flame spread due to polyacrylate. Further, the aluminum trihydrate also serves as an antioxidant for aluminum hydroxide. When heating to 205° C., 35% of crystal water is emitted as water vapor, and the surface of a product is cooled below the flashing point, and thereby greatly reducing a risk of fire.

Aluminum hydroxide is a flame retardant suitable for the standard of usage of eco-friendly raw materials in Korea, and may generate water vapor to delay smoke release when exposed to flames, and secure time to evacuate human life.

Titanium prevents discoloration and is used as an additive to the paint pigment. Paints made of titanium dioxide are resistant to harsh temperatures and marine environments. In addition, titanium forms a stable oxide film at normal room temperature to prevent corrosion when it comes into contact with seawater, moisture, or outside air. Further, titanium has excellent corrosion resistance after gold and platinum, and is light due to its low density while having excellent strength. Further, titanium has a density of 60% higher than that of aluminum and a strength of more than twice that of aluminum, and is well resistant to sulfur even when in contact therewith. In addition, although titanium is more expensive than aluminum, it has high strength, is lightweight, and is a non-toxic material that is harmless to the human body.

Further, titanium dioxide, as a kind of photocatalyst, has antifouling, air purification, antibacterial, deodorizing, and water purification performances. The antifouling performance refers to properties capable of decomposing and removing contaminants which are adhered to the surface of a substrate by super-hydrophilic action of a TiO₂ photocatalyst. Through these properties, it is possible to easily maintain facilities, thus to be widely used for exterior walls of a building. Due to an air purification effect, NOx and SOx may be removed from the air. Due to the antibacterial performance, it is possible to sterilize and prevent spoilage of viruses, bacteria, and fungi. Through deodorization, substances such as ammonia, acetaldehyde, VOCs, and odors may be removed. Water purification allows harmful compounds mixed in wastewater to be decomposed and removed.

When TiO₂ is irradiated with ultraviolet rays, TiO₂ receives energy from the ultraviolet rays to generate holes and electrons, which react with H₂O and O₂ in the air to generate oxidizing substances (OH., O2−). The generated material reacts with NOx and SOx to remove pollutants.

When a general paint coating film is exposed to ultraviolet rays for a long time, the film is deteriorated, resulting in color differences such as yellowing due to ultraviolet irradiation, and physical properties are weakened, thereby frequently causing a breakage of the film. One solution to suppress a deterioration in the coating film due to ultraviolet rays is to increase a content of titanium dioxide powder.

Titanium dioxide may be added in an amount of 16% or more to the color coating paint of embodiments of the present invention. The content of titanium dioxide may be 10 to 40%, and in one embodiment, 16 to 40% or 16 to 30%. Photocatalytic paints may have the increased content of titanium dioxide because of frequent breakage of the coating film due to agglutinability of TiO₂ itself if the content of TiO₂ exceeds 10%. However, the color coating paint of embodiments of the present invention does not cause breakage of the coating film even if the TiO₂ content is increased up to 40% due to unique mix of the composition and titanium dioxide which can be physically evenly dispersed in the paint, and has excellent surface adhesion to the soft or foam material, such that the coating film is not broken even when exposed to ultraviolet rays after drying.

Silicone has a melting point of 1414° C., which is the second highest among non-metals, and retains excellent elasticity, which is comparable to that of rubber foam thermal insulation material. In addition, silicon has no corrosion, excellent heat resistance, abrasion resistance, and cold resistance, and has a chemically very stable structure. Silicone rubber is non-toxic, and has the best cold resistance among all types of rubber. In terms of the cold resistance, synthetic rubber has a saturation point of −20° C. to −40° C., whereas silicone rubber has a saturation point of −60° C. to −70° C., such that it is possible to maintain the elasticity of the rubber, and add various colors thereto.

Sulfur serves to increase a strength of the polyacrylate rubber.

In one embodiment of the present invention, the filler may include one or more selected from the group consisting of talc, diatomite, glass bead, silica balloon, zirconia, alumina, ceramic bead, spherical ceramic particles, thermally expandable microcapsule, and capsule type hollow microspheres.

The filler contains air due to a porous structure or an internal hollow structure, which serves to form a constant air layer over the entire paint, thereby further enhancing thermal insulation and suppressing an increase in the surface temperature due to moisture permeation and external exposure of the thermal insulation material. In addition, the filler also has a sound insulation function that reduces internal noise by 10% or more.

The filler may be included in a content of 5 to 15 parts by weight based on 100 parts by weight of the color coating paint. If the content of the filler is less than 5 parts by weight, a separate waterproof and heat insulation layer cannot be formed on the coating film, and if the content of the filler exceeds 15 parts by weight, in a process of mixing, dispersing and drying together with a resin to which acrylic or urethane is added, spherical vacuum ceramic particles float on the surface of the coating film, such that a curing process is not smoothly performed. Therefore, it is difficult to additionally form a waterproof and heat insulation layer.

In one embodiment of the present invention, when manufacturing the color coating paint of embodiments of the present invention, a paint mixture may be physically evenly dispersed by stirring it for 30 minutes to 3 hours.

The physically uniform dispersion refers to a technique in which titanium dioxide is evenly dispersed in a resin and water, such that titanium dioxide may be evenly dispersed on the painted surface even when drying after painting.

The dispersion process is performed by using a high-speed stirrer, ultrasonic cleaner, a paint shaker, a disper and the like.

Titanium dioxide powder is ultra-fine nanoparticles having a particle diameter of 20 to 30 nm, and these particles are mostly present in a form of agglomerated secondary particles. Therefore, in order to obtain maximum photocatalytic effect, titanium dioxide powder should be dispersed into individual primary particles. In embodiments of the present invention, a paint shaker is used to stir the mixture for 30 minutes to 4 hours so that the particles have a particle size of about 0.3 to 1 μm.

In one embodiment, by having the particle size of 0.3 to 1 μm through the stirring process, the mixture is distributed as evenly as possible so that the primary particles of titanium dioxide occupy most of the powder, and by increasing the content of titanium dioxide to be contained in a high content, the adhesion of the coating film is improved while enhancing photocatalytic performance, and the coating film is maintained without breakage even when forming the coating film after drying the paint. If the particle size is outside the above range, the color coating paint does not exhibit the above-described characteristics.

If the stirring time is less than 30 minutes, the individual particles are not completely dispersed, the powder is not fixed to the surface of an object to be coated by a binder, and the adhesion of the coating film is very poor. If the stirring time exceeds 4 hours, the productivity is decreased.

Since the conventional photocatalytic paint has a large particle size, there is a difficulty due to clogging of the nozzle even when painting with an airless sprayer having a relatively large nozzle diameter as well as an air gun having a small nozzle diameter. However, by the dispersion treatment of the high-speed mixer, the color coating paint of embodiments of the present invention has a small and uniform particle size, and due to the unique composition of the color coating paint according to embodiments of the present invention, a viscosity thereof is uniformly maintained during spraying, and thereby improving workability.

In one embodiment of the present invention, when manufacturing the color coating paint, the viscosity thereof may be 50 to 1000 cps or less. If the viscosity of the color coating paint is less than 50 cps, it is very difficult to uniformly maintain the viscosity during spraying, and if the viscosity thereof is 1000 cps or more, coating by an airless sprayer or an air gun sprayer is impossible.

Embodiments of the present invention provide a rubber foam thermal insulation material coated with a color coating paint, including: a rubber foam formed in a shape of a tube or sheet; and an ink coating layer formed by coating the above-described color coating paint on a surface of the rubber foam in a predetermined thickness.

A rubber foam thermal insulation material M coated with the color coating paint according to embodiments of the present invention may include a rubber foam R formed in a shape of a tube or sheet; and an ink coating layer C formed by coating the above-described color coating paint on a surface of the rubber foam R in a predetermined thickness.

The rubber foam R is made by molding and foaming rubber into a predetermined shape, and has a higher density and better thermal insulation (heat insulation) effect than a crosslinked thermal insulation material (heat insulation material).

In embodiments of the present invention, the rubber foam R is formed in a shape of the tube covering a pipe or the like or a shape of the sheet covering the surface of devices or tanks, and has a predetermined thickness.

The ink coating layer C coated with the above-described color coating paint is formed on the surface of the rubber foam R.

The thickness of the ink coating layer C may be selectively adjusted by controlling a distance and an injection amount of an injection means according to the thickness and use of the rubber foam R, which will described below.

In this way, the rubber foam thermal insulation material M having the ink coating layer C formed thereon in a thickness of several tens to several hundred μm may be manufactured in the shape of tube or sheet.

Accordingly, the rubber foam thermal insulation material M according to embodiments of the present invention has an advantage of improving construction performance because the ink coating layer C formed on the surface of the rubber foam R is uniformly maintained even after drying, and has excellent elasticity.

The color coating paint of embodiments of the present invention may be applied to a surface regardless of the material or condition of the surface to be painted, and may be coated to a soft or porous surface due to elasticity provided therein.

The coating film produced by the color coating paint according to embodiments of the present invention blocks 95% or more of the emission of volatile organic compounds from the surface of the foam rubber thermal insulation material into the atmosphere.

The coating film produced by the color coating paint of embodiments of the present invention has a high photocatalytic effect and a function of preventing UV deterioration by avoiding or minimizing breakage occurring in the coating film of the paint containing titanium dioxide in a high content.

The color coating paint of embodiments of the present invention improves the anti-moisture permeability and thermal insulation performance of the thermal insulation material.

The color coating paint of embodiments of the present invention may be applied with colors in accordance with a process such as water supply, hot water supply, firefighting, air conditioning, and the like by mixing pigments having colors according to the use, and enables perfect coloring.

When coating a thermal insulation material or the like with the color coating paint of embodiments of the present invention, contaminants on the surface may be easily cleaned.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a photograph illustrating application of colors and adhesion state of a coating film according to use by mixing various pigments with paints of Examples 1 and 2;

FIG. 2 are photographs illustrating experiments that, when the thermal insulation material coated with the paint of Example 2 in Experimental Example 1 was folded or bent at to 180°, the coating was maintained over the entire surface without an occurrence of a breakage of the coating film;

FIG. 3 are photographs illustrating the adhesion state of the coating film when the paints of Examples 1 and 2 were applied to the surface of the rubber foam thermal insulation material and then subjected to a test such as bending;

FIG. 4 are photographs illustrating results of the surface temperature measurement experiment in Experimental Example 3; and

FIG. 5 is schematic views illustrating a rubber foam thermal insulation material coated with the color coating paint according to embodiments of the present invention, wherein (a) shows a tube-shaped thermal insulation material and (b) shows a sheet-shaped thermal insulation material.

### DETAILED DESCRIPTION OF EMBODIMENTS

Hereinafter, embodiments of the present invention will be described in detail with reference to examples, and the present invention is not limited to the following examples. For reference, the terms and words used in the present disclosure and claims of the present invention should not be construed as limited to a lexical meaning, and should be understood as appropriate notions by the inventor based on that he/she is able to define terms to describe his/her invention in the best way to be seen by others. In addition, embodiments and drawings described in the present disclosure are example embodiments and do not represent all the technical sprites of the present invention, and it will be understood that various modifications and equivalents may be made to take the place of the embodiments at the time of filling the present application.

Photocatalysts using titanium dioxide (TiO₂) are representative materials that can reduce the precursors, which are a cause of forming the secondary pollutants, and have properties of decomposing organic materials through a light reaction with ultraviolet rays. There may be techniques for producing a paint containing titanium dioxide that can be used indoors by using photocatalytic properties of the titanium dioxide and can reduce primary and secondary pollutants of fine dust. Studies into water-soluble paints containing titanium dioxide are being actively conducted in the field of photocatalysts having functions of decomposition of nitric oxide and sulfur oxide, antibacterial and virus sterilization functions, and a function of removal of VOCs. There may be possibility of applying the water-soluble paints not only to indoor walls but also to thermal insulation materials of industrial facilities, etc.

The thermal insulation material is applied to various thermal insulation works such as building equipment construction and industrial equipment construction for thermal insulation, cold reservation, condensation prevention, and freeze protection of pipes, ducts, devices and tanks, and includes glass wool thermal insulation materials, polyethylene (PE) thermal insulation materials, rubber foam thermal insulation materials and the like.

The rubber foam thermal insulation material is a closed cell elastomer, and is made in a fine independent closed cell structure composed of nitrile butadiene rubber (NBR) and various synthetic mixtures, thereby having excellent thermal insulation and easy workability. This thermal insulation material is used in general building equipment, shipbuilding, refrigeration, and plant fields to prevent moisture from penetrating even if a surface thereof is damaged, and has excellent thermal insulation and cold reservation properties.

Due to a carbon black component added to reinforce inherent properties and abrasion resistance of rubber, such a rubber foam thermal insulation material is dark black, and is manufactured in a fine closed cell structure to reduce thermal conductivity, thereby having characteristics that the surface thereof is soft.

As a means for further improving the thermal insulation performance of the rubber foam thermal insulation material, there may be a need to develop a technique capable of forming a coating film on the surface of the thermal insulation material by reducing a water vapor permeability coefficient and increasing airtightness. However, in the existing water-based paint, solid matters are cured after water which plays a role of solvent is dried to form a coating film. At this time, the resulting coating film is mainly used for solid wall painting, but an elasticity of the coating film itself is weak and an adhesive force to an elastic pipe with a soft surface, a wall composed of a foam material, and the thermal insulation material, etc. may be very small, such that there is a technical limitation in which coating may be impossible.

Due to the limitation that no paint is adhered to soft or porous materials, in order to identify the use of thermal insulation material, in particular, a pipe wrapped with the rubber foam thermal insulation material, colored tapes or bonding thick films may be used with an adhesive, or the rubber foam thermal insulation material using pigments while excluding carbon may be produced. However, all of these methods have a drawback of reducing the durability, elasticity or thermal insulation of the rubber foam thermal insulation materials.

One implementation may provide non-toxic and flame-retardant ink which can be adhered to the surface of a rubber foam thermal insulation material. Due to this technique, it may be possible to improve the construction performance by enhancing the elasticity of the rubber foam thermal insulation material, and increase the flame-retardance and anti-moisture permeability of the entire rubber foam thermal insulation material.

In this regard, the above technique may provide uniform coating on the amorphous surface, but when adding an amount of titanium dioxide powder in a certain amount or more, the coating film is severely peeled off and the coating film is broken, and thereby a photocatalytic effect is significantly reduced.

In addition, the coating film is broken when the shape changes according to an installation shape of the thermal insulation material after coating and is separated from the surface of the thermal insulation material, and thus, it is difficult to apply the foregoing technique to actual building and industrial equipment constructions.

Examples of the present disclosure are discussed below.

### Example 1: Color Coating Paint

25 g of polyacrylate, 5 g of polyurethane, 30 g of titanium dioxide, 2 g of aluminum hydroxide, 10 g of calcium carbonate, 2 g of silica, 3 g of silica sol, 1 g of sulfur, 5 g of colored pigment, and 60 g of water were mixed, and the mixture was stirred at 500 rpm for 2 hours or more to prepare a color coating paint composition.

### Example 2: Insulation Color Coating Paint

25 g of polyacrylate, 5 g of polyurethane, 25 g of titanium dioxide, 2 g of aluminum hydroxide, 10 g of calcium carbonate, 2 g of silica, 3 g of silica sol, 15 g of spherical ceramic particles, 1 g of sulfur, 5 g of colored pigment, and 60 g of water were mixed, and the mixture was stirred at 500 rpm for 2 hours or more to prepare a color coating paint composition.

### Comparative Example 1

57 g of water, 20 g of polyacrylate, 7 g of CaCO₃, 10 g of aluminum hydroxide, 0.5 g of silicon, 8 g of titanium dioxide, and 0.5 g of sulfur were mixed, and the mixture was stirred at 500 rpm for 30 minutes to prepare a color coating paint composition.

### Comparative Example 2

30 g of polyacrylate, 80 g of titanium dioxide, 2 g of aluminum hydroxide, 10 g of calcium carbonate, 2 g of silica, 3 g of silica sol, 1 g of sulfur, 5 g of colored pigment, and 60 g of water were mixed, and the mixture was stirred at 500 rpm for 2 hours or more to prepare a color coating paint composition.

### Experimental Example 1: Surface Application Experiment

Each of the paints of Examples 1 and 2 and Comparative Example 3 (commercially available water-based paint, company N) was applied to a surface of a rubber foam thermal insulation material using a spray in a thickness of 50 μm (increased or decreased depending on the degree of adhesion), followed by naturally curing at 20° C. for 24 hours to prepare a test specimen of embodiments of the present invention.

TABLE 1

| | TiO₂ | Immediately after | | | |
|---|---|---|---|---|---|
| | content | curing | Bending at 30° | Bending at 90° | Bending at 150° |
| Example 1 | (21.1%) | Excellent coating | Coating film | Coating film | Coating film |
| | | film adhesion (film | maintained | maintained | maintained |
| | | thickness: 50 μm) | | | |
| Example 2 | (16.4%) | Excellent coating | Coating film | Coating film | Coating film |
| | | film adhesion | maintained | maintained | maintained |
| | | (50 μm) | | | |
| Comparative | (22%) | Film is adhered | Coating film | Coating film | Coating film |
| Example 3 | | only when | partially broken | broken | broken Thermal |
| | | increasing the | | | insulation |
| | | thickness thereof by | | | material |
| | | 40% or more | | | damaged |
| | | compared to | | | |
| | | Examples 1 and 2. | | | |
| Comparative | (7.8%) | Adhered (50 μm) | Coating film | — | — |
| Example 1 | | | broken | | |
| Comparative | (41%) | Almost not adhered | — | — | — |
| Example 2 | | | | | |

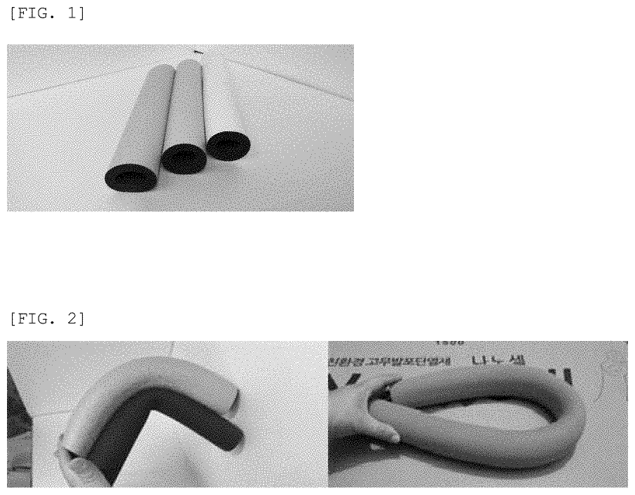

Existing products may only be used for hard-surface walls, but the color coating paints of Examples 1 and 2 of the present invention have an advantage capable of being applied to the coating film without breakage of the surface thereof in a material having a stretchable surface. FIG. 1 is a photograph illustrating a state when the color coating paint of Example 1 was applied and dried.

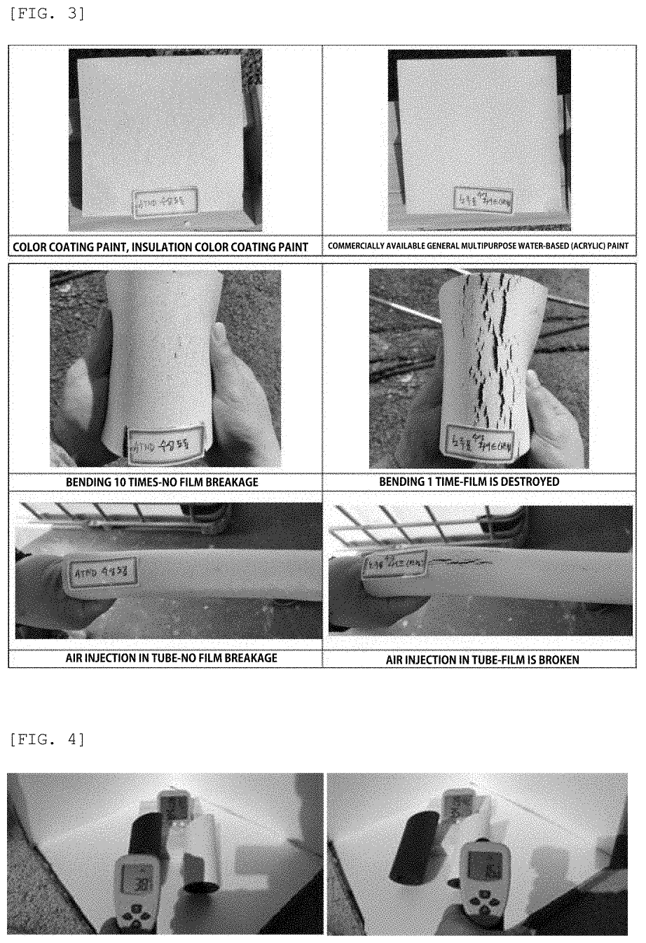

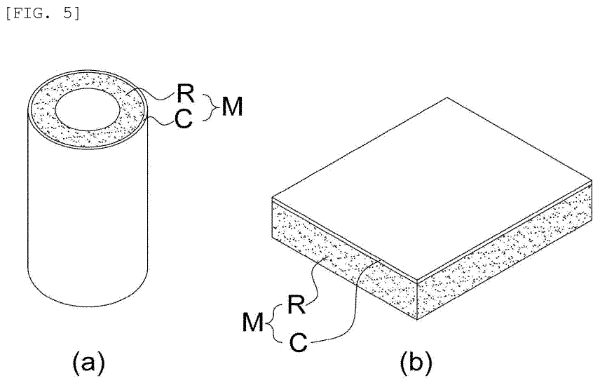

The color coating paint may be applied to the surface of foam thermal insulation materials such as a rubber foam thermal insulation material with high elasticity. As shown in FIG. 2, the color coating paint of Example 2 does not break at the surface of the coating film even when bending at about 150 to 180° or more, and retains excellent elasticity, such that the surface of the coating film is not cracked even when repeatedly bending.

FIG. 3 are photographs illustrating experimental results of Experimental Example 1. In commercially available general high-functional acrylic water-based paints (N company, white semi-gloss), the coating film of the surface is easily broken when the elastic thermal insulation material is bent and expanded by air pressure even after completely drying, thereby resulting in a deterioration of the photocatalytic function due to titanium dioxide. Whereas, the color coating paint according to Example 1 of the present invention maintains the coating film on the surface even when applying the paint in a lower thickness, and bending 10 times or more and expanding by air injection.

### Experimental Example 2: Thermal Insulation Effect Experiment

The uncoated rubber foam thermal insulation material (thermal conductivity: 0.035 W/m·k) and the rubber foam thermal insulation material coated with the paint of Example 2 were exposed to direct sunlight under conditions including an ambient temperature of 19.1 to 19.4° C. and a humidity of 35 to 36% for 60 minutes.

Results of measuring an increase in the temperature by direct sunlight on the surface of each rubber foam thermal insulation material is shown in photographs of FIG. 3. When comparing the experimental results, the surface temperature of the uncoated rubber foam thermal insulation material is 38.7° C., and the surface temperature of the rubber foam thermal insulation material coated with the paint of Example 2 is 16° C., such that it can be seen that a heat shielding effect is excellent.

Assuming that areas of the rubber foam thermal insulation materials are the same as each other, it can be seen that the thermal conductivity transmitted to the pipe is reduced due to a decrease in the surface temperature, such that the thermal insulation effect of the thermal insulation material may be further increased. The reason is that, when adding spherical ceramic particles to the water-soluble color coating paint containing titanium dioxide, air in a vacuum state inside the spherical ceramic particles plays a role of a heat insulation material when applying it to the outer wall and the thermal insulation material, and thereby reducing the thermal conductivity on the surface of the thermal insulation material.

### Experimental Example 3: Changes in Physical Properties of Rubber Foam Thermal Insulation Material During Coating

As a result of the test, the rubber foam thermal insulation material coated with the color coating paint showed the following improvements in main performances.

TABLE 2

| | | | | | General | Coating | |
|---|---|---|---|---|---|---|---|
| | | | | | rubber | foam of | |
| | | | KS | | foam | Example | |
| Test item | | Unit | standard | Standard | material | 1 | Test method |
| Water vapor | | ng/m² · | 6 or less | 6 or less | 5 | 1.1 | KSM 6962 |
| permeability | | s · Pa | | | | | |
| coefficient | | | | | | | |
| Dimensional | Horizontal | % | Horizontal | 5 or less | −1.0 | 0 | KSM 6962 |
| safety | direction | | 7 or less | | | | |
| [(40 ± 2)° C., | Longitudinal | % | Longitudinal | 5 or less | −1.2 | 0 | KSM 6962 |
| 48 h] | direction | | 7 or less | | | | |

| | | | | | |
|---|---|---|---|---|---|
| TVOCs emission | mg/m² · h | 4.0 or less | 0.151 | 0.061 | Indoor air quality |
| | | | | | process test |
| | | | | | standards (Notified |
| | | | | | by the Minister of |
| | | | | | Environment) |
| Toluene emission | mg/m² · h | 0.08 or | Less than | Not | Indoor air quality |
| | | less | 0.001 | detected | process test |
| | | | | | standards (Notified |
| | | | | | by the Minister of |
| | | | | | Environment) |

When water vapor permeates the foamed thermal insulation material, the thermal conductivity is rapidly increased to cause a great reduction in the thermal insulation performance. In order to maintain the thermal insulation performance of the foamed thermal insulation material, the most important water vapor permeability coefficient was lowered by 78%. In terms of dimensional stability, the larger+/−values, the greater a deformation of the thermal insulation material according to the external temperature, and expansion as well as contraction of the thermal insulation material did not occur according to the external temperature. TVOCs were reduced by 60% or more, and toluene was not detected at all, which proved effective in improving the indoor air quality. This is because a considerable amount of TVOCs are emitted from the rubber foam thermal insulation material itself, but such an emission may be prevented by the coating.

### DESCRIPTION OF REFERENCE NUMERALS

M: Rubber foam thermal insulation material
R: Rubber foam
C: Ink coating layer

What is claimed is:

1. A color coating paint comprising 10 to 40 parts by weight of polyacrylate and a polyurethane mixture, 15 to 40 parts by weight of titanium dioxide, 5 to 10 parts by weight of calcium carbonate, 1 to 5 parts by weight of aluminum hydroxide, 0.5 to 5 parts by weight of a silicone resin, 0.1 to 1 parts by weight of sulfur, 0.5 to 10 parts by weight of a colored pigment, and 40 to 60 parts by weight of water.

2. The color coating paint according to claim 1, wherein the polyacrylate includes poly butyl acrylate or poly n-butyl methacrylate.

3. The color coating paint according to claim 1, wherein the polyurethane includes polyester urethane (AU), polyether urethane (EU) or a urethane resin.

4. The color coating paint according to claim 1, wherein a mixing ratio of the polyacrylate and polyurethane mixture is 1:0.1 to 5.

5. A method for manufacturing a color coating paint comprising:
stirring the color coating paint according to claim 1; and
stirring a mixture so that particles of the color coating paint have a particle size of 0.3 to 1 μm.

6. A method for manufacturing a color coating paint comprising:
stirring the color coating paint according to claim 1 for 1 to 4 hours; and
evenly dispersing a mixture.

7. The method for manufacturing a color coating paint according to claim 6, wherein the color coating paint has a viscosity of 50 to 1000 cps.

8. A rubber foam thermal insulation material coated with a color coating paint, comprising:
a rubber foam formed in a shape of a tube or sheet; and
an ink coating layer formed by coating the color coating paint of claim 1 on a surface of the rubber foam in a predetermined thickness.

9. A color coating paint comprising 10 to 40 parts by weight of polyacrylate and a polyurethane mixture, 10 to 30 parts by weight of titanium dioxide, 5 to 15 parts by weight of filler, 5 to 10 parts by weight of calcium carbonate, 1 to 5 parts by weight of aluminum hydroxide, 0.5 to 5 parts by weight of a silicone resin, 0.1 to 1 parts by weight of sulfur, and 40 to 60 parts by weight of water.

10. The color coating paint according to claim 9, wherein the polyacrylate includes poly butyl acrylate or poly n-butyl methacrylate.

11. The color coating paint according to claim 9, wherein the polyurethane includes polyester urethane (AU), polyether urethane (EU) or a urethane resin.

12. The color coating paint according to claim 9, wherein a mixing ratio of the polyacrylate and polyurethane mixture is 1:0.1 to 5.

13. The color coating paint according to claim 9, wherein the filler includes one or more selected from the group consisting of talc, diatomite, glass bead, silica balloon, zirconia, alumina, ceramic bead, spherical ceramic particles, thermally expandable microcapsule, and capsule type hollow microspheres.

14. A method for manufacturing a color coating paint comprising:
stirring the color coating paint according to claim 9; and
stirring a mixture so that particles of the color coating paint have a particle size of 0.3 to 1 μm.

15. A method for manufacturing a color coating paint comprising:
stirring the color coating paint according to claim 9 for 1 to 4 hours; and
evenly dispersing a mixture.

16. The method for manufacturing a color coating paint according to claim 15, wherein the color coating paint has a viscosity of 50 to 1000 cps.

17. A rubber foam thermal insulation material coated with a color coating paint, comprising:
a rubber foam formed in a shape of a tube or sheet; and
an ink coating layer formed by coating the color coating paint of claim 9 on a surface of the rubber foam in a predetermined thickness.
